(19) United States
(12) Patent Application Publication
(10) Pub. No.: US 2021/0168831 A1
(43) Pub. Date: Jun. 3, 2021

(54) Access Point, Station, Methods and Computer Programs

(71) Applicant: Telefonaktiebolaget LM Ericsson (publ), Stockholm (SE)

(72) Inventors: Leif Wilhelmsson, Lund (SE); Naveed Butt, Skaka (SA); Rocco di Taranto, Lund (SE); Dennis Sundman, Sollentuna (SE)

(21) Appl. No.: 16/613,664

(22) PCT Filed: Nov. 2, 2017
(86) PCT No.: PCT/EP2017/078050

§ 371 Date: Nov. 14, 2019

Related U.S. Application Data
(60) Provisional application No. 62/508,005, filed on May 18, 2017.

(51) Int. Cl. H04W 72/12; H04W 72/04

(52) U.S. Cl. CPC H04W 72/1215; H04W 88/10; H04W 72/0453

(57) ABSTRACT

An access point is arranged for serving both wideband wireless stations and narrowband wireless stations where the narrowband wireless stations operate on a subset of the bandwidth on which the wideband wireless stations operate. The access point comprises a transceiver and a controller. The controller is arranged to schedule simultaneous usage of a first set of subcarriers for a wideband station and a first narrowband wireless station by causing the transceiver to transmit a first subcarrier suggestion, about the first set of subcarriers to be used, to the first narrowband wireless station and to transmit a modulation and coding scheme, MCS suggestion, about subcarriers including the first set of subcarriers to be used, to the wideband station. The suggested MCS is adapted to have increased robustness in view of any interference on a transmission from the wideband wireless station caused by a transmission from the first narrowband wireless station in the first set of subcarriers. A station arranged to communicate with the access point, and methods and computer programs are also disclosed.

### TECHNICAL FIELD

The present disclosure generally relates to an access point and to a station arranged to communicate with the access point, and to methods and computer programs therefor. In particular, the disclosure relates to adapting modulation and coding scheme to enable co-existence of narrowband stations and wideband stations making concurrent uplink transmissions.

### BACKGROUND

Internet of Things (IoT) is expected to increase the number of connected devices significantly. A vast majority of these devices will likely operate in unlicensed bands, in particular the 2.4 GHz ISM band. At the same time, there is also increased demand for using the unlicensed bands for services that traditionally have been supported in licensed bands. As an example of the latter, third generation partnership project (3GPP) that traditionally develop specifications only for licensed bands have now also developed versions of Long Term Evolution (LTE) which will operate in the 5 GHz unlicensed band.

In addition, IEEE 802.11, which traditionally operates in unlicensed bands, are currently developing an amendment, 802.11ax, which supports new features that are usually supported only in licensed bands. Examples of such features are for instance Orthogonal Frequency Division Multiple Access (OFDMA), both for the Up-link (UL) and the down-link (DL).

Technologies that are expected to dominate for IoT services are Bluetooth Wireless Technology, in particular Bluetooth Low Energy (BLE), and future versions of IEEE 802.11.

The IEEE submission IEEE 802.11-15/1375 with title “Support for IoT—Requirements and Technological Implications” suggests that it may be beneficial in an 802.11 OFDMA air interface for IoT to leave parts of the spectrum vacant for other technologies such as Bluetooth or Zigbee. For this to be effective, however, the 802.11 OFDMA air interface must be flexible enough both when it comes to how much of the bandwidth can be allocated to the other system and where, within the total bandwidth, the IoT system can be placed.

For easier understanding of the description, 802.11ax is used as a tangible example of the wide band system. Specifically, it is assumed that the nominal channel bandwidth is 20 MHz, that the signal is generated using a 256-point inverse fast Fourier transform (IFFT), so that the sub-carrier spacing becomes 20/256 MHz=78.125 kHz, and that the duration of one OFDMA symbol is 256/20 us=12.8 us, not including the cyclic prefix (CP).

IEEE 802.11ax has support for OFDMA, meaning that the 20 MHz spectrum can be divided into resource units (RU) of various size. In case of a 20 MHz channel, there are only four sizes for a RU, corresponding roughly to 2, 4, 8, and 18 MHz (the last corresponding to use of the full channel). RU allocation examples for IEEE 802.11ax are depicted in FIG. 14, where numbers in the bands indicate number of subcarriers for a total allocation of 20 MHz. An IEEE 802.11ax STA can only be assigned one RU at a time.

### SUMMARY

By considering uplink (UL) transmissions from narrowband stations (NB STAs) as known interferers in view of wideband station (WB STA) UL transmissions and adapting the modulation and coding scheme (MCS) to withstand this, an efficient usage of bandwidth commonly used for WB and NB STAs is achieved.

According to a first aspect, there is provided an access point arranged for serving both wideband wireless stations and narrowband wireless stations where the narrowband wireless stations operate on a subset of the bandwidth on which the wideband wireless stations operate. The access point comprises a transceiver and a controller. The controller is arranged to schedule simultaneous usage of a first set of subcarriers for a wideband station and a first narrowband wireless station by causing the transceiver to transmit a first subcarrier suggestion, about the first set of subcarriers to be used, to the first narrowband wireless station and to transmit a modulation and coding scheme, MCS suggestion, about subcarriers including the first set of subcarriers to be used, to the wideband station. The suggested MCS is adapted to have increased robustness in view of any interference on a transmission from the wideband wireless station caused by a transmission from the first narrowband wireless station in the first set of subcarriers.

The controller may be arranged to schedule simultaneous usage of a second set of subcarriers for a second narrowband wireless station by causing the transceiver to transmit a second subcarrier suggestion about the second set of subcarriers to be used to the second narrowband wireless station. The subcarriers used by the wideband wireless station may include the second set of subcarriers and the increased robustness of the suggested MCS may also be adapted to be in view of any interference on a transmission from the wideband wireless station caused by a transmission from the second narrowband wireless station in the second set of subcarriers.

The MCS with increased robustness may have increased robustness in view of an MCS that would have been used based on channel status of the wideband wireless station in absence of any interference from a narrowband wireless station.

A suggested subcarrier to be used by a narrowband wireless station may be selected among the subcarriers to be used by the wideband wireless station where channel status of the wideband wireless station is worse than for another of the subcarriers to be used by the wideband wireless station. The selection of the suggested subcarrier may be a subset of subcarriers of the subcarriers to be used by the wideband wireless station having the worst channel status and is not used by another narrowband wireless station.

The controller may be arranged to cause the transceiver to transmit to the wideband wireless station information about one or more subcarriers expected to be interfered by narrowband stations. The information about the one or more subcarriers expected to be interfered by narrowband wireless stations may be transmitted along with the MCS suggestion.

According to a second aspect, there is provided a wideband wireless station arranged to operate under control of an access point arranged for serving both wideband wireless stations and narrowband wireless stations where the narrowband wireless stations operate on a subset of the bandwidth on which the wideband wireless stations operate. The wideband wireless station comprises a transceiver and a controller. The transceiver is arranged to receive a modulation and coding scheme, MCS, suggestion for the subcarriers to be used. The controller is arranged to control preparation of transmissions to the access point to be adapted based on the MCS suggestion. The transceiver is arranged to transmit the prepared transmission.

The transceiver of the wideband wireless station may be arranged to receive information about one or more sets of subcarriers expected to be interfered by the narrowband wireless stations. The controller of the wideband wireless station may be arranged to cause cancelling of subcarriers corresponding to the one or more sets of subcarriers expected to be interfered by the narrowband wireless stations. The information about the one or more sets of subcarriers expected to be interfered by the narrowband wireless stations may be received from the access point. Alternatively, the information about the one or more sets of subcarriers expected to be interfered by the narrowband wireless stations may be received by monitoring a channel between the access point and the wireless stations.

The received suggested MCS may comprise a MCS which is adapted to have increased robustness in view of any interference on a transmission from the wideband wireless station to the access point caused by transmissions from the narrowband wireless stations, wherein the applied MCS for the preparation of transmissions to the access point is the suggested MCS. Alternatively, the applied MCS for the preparation of transmissions to the access point may be based on the received suggested MCS, but is adapted to have increased robustness in view of any interference on a transmission from the wideband wireless station to the access point caused by transmissions from the narrowband wireless stations.

According to a third aspect, there is provided a method of an access point which is arranged for serving both wideband wireless stations and narrowband wireless stations where the narrowband wireless stations operate on a subset of the bandwidth on which the wideband wireless stations operate. The method comprises scheduling simultaneous usage of a first set of subcarriers for a wideband station and a first narrowband wireless station, transmitting a first subcarrier suggestion, about the first set of subcarriers to be used, to the first narrowband wireless station, and transmitting a modulation and coding scheme, MCS suggestion, about subcarriers including the first set of subcarriers to be used, to the wideband station, wherein the suggested MCS is adapted to have increased robustness in view of any interference on a transmission from the wideband wireless station caused by a transmission from the first narrowband wireless station in the first set of subcarriers.

The method may comprise scheduling simultaneous usage of a second set of subcarriers for a second narrowband wireless station, and transmitting a second subcarrier suggestion about the second set of subcarriers to be used to the second narrowband wireless station, wherein the subcarriers used by the wideband wireless station includes the second set of subcarriers and the increased robustness of the suggested MCS is also adapted to be in view of any interference on a transmission from the wideband wireless station caused by a transmission from the second narrowband wireless station in the second set of subcarriers.

The MCS with increased robustness may have increased robustness in view of an MCS that would have been used based on channel status of the wideband wireless station in absence of any interference from a narrowband wireless station.

The method may comprise selecting a suggested subcarrier to be used by a narrowband wireless station among the subcarriers to be used by the wideband wireless station where channel status of the wideband wireless station is worse than for another of the subcarriers to be used by the wideband wireless station. The selecting of the suggested subcarriers may comprise selecting a set of subcarriers of the subcarriers to be used by the wideband wireless station having the worst channel status and is not used by another narrowband wireless station.

The method may comprise transmitting information about one or more sets of subcarriers expected to be interfered by narrowband stations to the wideband wireless station. The transmitting of the information about the one or more sets of subcarriers expected to be interfered by narrowband wireless stations may be made along with the transmitting of the MCS suggestion.

According to a fourth aspect, there is provided a method of a wideband wireless station which is arranged to operate under control of an access point which is arranged for serving both wideband wireless stations and narrowband wireless stations where the narrowband wireless stations operate on a subset of the bandwidth on which the wideband wireless stations operate. The method comprises receiving information about at least one of a modulation and coding scheme, MCS, suggestion about subcarriers to be used, and one or more sets of subcarriers expected to be interfered by the narrowband wireless stations where the sets of subcarriers are subsets of the subcarriers to be used. The method further comprises selecting an MCS based on the received information, preparing a transmission to the access point based on the MCS selection, and transmitting the prepared transmission.

The method may comprise cancelling subcarriers corresponding to the one or more sets of subcarriers expected to be interfered by the narrowband wireless stations.

The receiving of the information about the one or more sets of subcarriers expected to be interfered by the narrowband wireless stations may comprise receiving the information from the access point. Alternatively, the receiving of the information about the one or more sets of subcarriers expected to be interfered by the narrowband wireless stations may comprise monitoring a channel between the access point and the wireless stations and acquiring the information therefrom.

The received suggested MCS may comprise a MCS which is adapted to have increased robustness in view of any interference on a transmission from the wideband wireless station to the access point caused by transmissions from the narrowband wireless stations, wherein the applied MCS for the preparing of transmissions to the access point is the suggested MCS. Alternatively, the applied MCS for the preparing of transmissions to the access point may be based on the received suggested MCS, but is adapted to have increased robustness in view of any interference on a transmission from the wideband wireless station to the access point caused by transmissions from the narrowband wireless stations.

According to a fifth aspect, there is provided a computer program comprising instructions which, when executed on a processor of an access point, causes the access point to perform the method according to the third aspect.

According to a sixth aspect, there is provided a computer program comprising instructions which, when executed on a processor of wideband wireless station, causes the wideband wireless station to perform the method according to the fourth aspect.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 schematically illustrates a frequency diagram for bandwidth resources to be used by a wideband wireless station and a subset bandwidth resource to be simultaneously used by a narrowband wireless station.

FIG. 2 schematically illustrates a system with an access point, wideband wireless stations and narrowband wireless stations.

FIG. 3 is a signal scheme illustrating operation according to an embodiment.

FIG. 4 is a signal scheme illustrating operation according to an embodiment.

FIG. 5 is a signal scheme illustrating operation according to an embodiment.

FIG. 6 is a block diagram schematically illustrating a wireless device according to embodiments.

FIG. 7 is a block diagram schematically illustrating preparation of an uplink transmission according to an embodiment.

FIG. 8 is a block diagram schematically illustrating preparation of an uplink transmission according to an embodiment.

FIG. 9 is a flow chart illustrating a method of an access point according to embodiments.

FIG. 10 is a flow chart illustrating a method of an access point according to an embodiment.

FIG. 11 schematically illustrates a computer-readable medium and a processing device of an access point.

FIG. 12 is a flow chart illustrating a method of a wideband wireless station according to embodiments.

FIG. 13 schematically illustrates a computer-readable medium and a processing device of a wideband wireless station.

FIG. 14 illustrates resource unit allocation examples for an exemplary system.

FIG. 15 illustrates a scenario where NB-STA and WB-STA transmits data simultaneous to the AP.

FIG. 16 illustrates RUs and left-over tones for a 20 MHz channel in IEEE 802.11ax.

FIG. 17 illustrates a simplified version of an OFDM receiver chain using a soft decoder.

FIG. 18 illustrates UL transmissions from WB (20 MHz) and NB (2 MHz) STAs where the AP receives both signals at the same time, partly overlapped on 2 MHz.

FIG. 19 schematically illustrates an UL signal processing model.

FIG. 20 schematically illustrates and overview on PHY packet format for NB signal.

FIG. 21 illustrates an example of packet structure for WB-NB UL transmissions, where WB preamble is sent on 20 MHz and NB signal starts after the WB preamble.

FIG. 22 illustrates WB STA blanks subcarriers corresponding to RU2.

FIG. 23 is a PER vs SIR chart for a simulation of UL WB transmission with SNR_WB=21 dB and MCS4.

FIG. 24 is a PER vs SIR chart for a simulation of TGn-D channel with MCS 2, 4 and 6, and SNR_WB=21 dB.

FIG. 25 is a PER vs SNR chart for a simulation of TGn-D channel with SIR=9 dB, and NB after WB HE preamble.

FIG. 26 is a PER vs SNR chart for a simulation of different channel models for overlay aware decoding, 1×2.

FIG. 27 is a PER vs total signal power ratio, i.e. WB power to NB power, chart for a simulation of WB STA blanks subcarriers corresponding to RU2.

### DETAILED DESCRIPTION

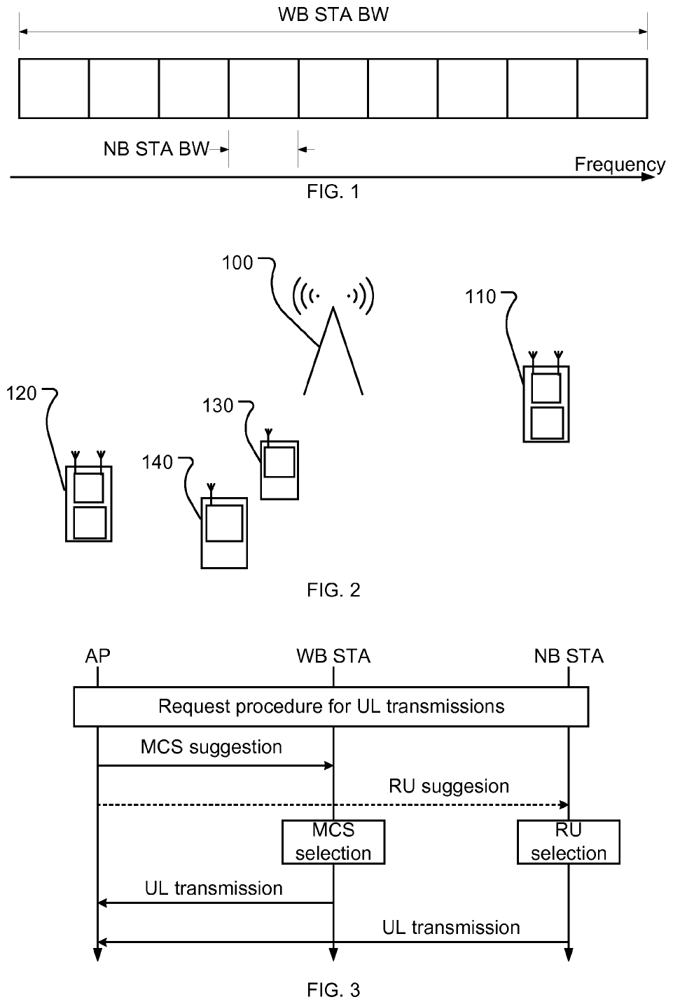

FIG. 1 schematically illustrates a frequency diagram for bandwidth (BW) resources to be used by a wideband (WB) wireless station (STA) and a subset BW resource to be simultaneously used by a narrowband (NB) wireless STA. Examples of such NB wireless STA, and corresponding method therefor, are disclosed in U.S. provisional application 62/503,361, filed 9 May 2017 by Telefonaktiebolaget LM Ericsson (publ), which application is hereby incorporated by reference in its entirety. Here, it can be seen that the issue contemplated in this disclosure is where the NB STA uplink (UL) transmissions overlaps the WB STA partly in both time and frequency, and will thus cause interference when the access point receives the UL transmission from the WB STA. Traditionally, this has been solved by allocating resources such that no overlap occurs, but this may degrade overall system performance. In this disclosure, the approach is instead to improve coding robustness of the UL transmission from the WB STA, assume that robustness then is sufficient for the NB STA UL transmission, and let the NB STA UL transmission overlap in time and with parts of the BW of the WB STA UL transmission. Exemplary systems for this is IEEE 802.11ax for the WB STA and Bluetooth Low Energy for the NB STA, for which some tangible examples are provided herein, but as the reader will understand from this disclosure, the approach is suitable for other combinations of systems.

Using orthogonal frequency division multiple access (OFDMA) to allocate a narrowband system to small part of the bandwidth available for a wideband system is a very simple and effective means to support both IoT applications as well as high data rate applications concurrently, at least in case the OFDMA system is designed with this feature in mind.

In IEEE 802.11ax OFDMA, arbitrary allocation of spectrum for a STA is not possible. Currently, if OFDMA is to be used to open a part of the spectrum for a narrowband device, the largest bandwidth that can be used for the wideband device, out of the full bandwidth (18 MHz), is 8 MHz. This results in a large performance degradation.

Even assuming an OFDMA system designed with narrowband support in mind, it requires knowledge at a transmitting STA of where the narrowband system will transmit. If such knowledge is not available, or the transmitting STA does not even support OFDMA, a narrowband interference may degrade the performance significantly.

In this disclosure, it is proposed to introduce a means to transmit a narrowband signal concurrently with a wideband signal in the UL by overlaying the narrowband signal. The approach can be made completely transparent for both the narrowband and the wideband transmitter, and the additional complexity can be put in the receiver in the network node. Instead of adapting the bandwidth of the wideband signal to allow for concurrent transmission of a narrowband signal, the modulation and coding scheme (MCS) is adjusted to account for that part of the bandwidth is interfered. The wideband transmitter may potentially be informed about what part of the spectrum will be allocated to a narrowband user, and in this way reduce the interference that the narrowband system will experience. The adjustment of MCS may also take into account how complex receiver processing is available and the relative power offset between the narrowband and the wideband signal at the network node.

The proposed solution provides efficient concurrent UL transmissions. The solution can result in higher spectrum efficiency and can be implemented in a way that may be transparent to the STAs.

FIG. 2 schematically illustrates a system with an access point (AP) 100, WB wireless STAs 110, 120 and NB wireless STAs 130, 140. The AP 100 may be the scheduler for the WB STAs or for the NB STAs, or both. The AP 100 may be arranged to operate according to a single access technology, or be a complex unit arranged to operate according to multiple access technologies. According to some embodiments, both the WB STAs and the NB STAs may be legacy devices, i.e., the only adaptations to achieve the improvements are made in the AP 100. According to some embodiments, the NB STAs may be legacy devices, while adaptations are made to the AP 100 and the WB STA 110, 120 performing a UL transmission as described herein.

FIG. 3 is a signal scheme illustrating operation according to an embodiment. In this embodiment, only the AP needs to have the particular features as described herein, while the WB STA and the NB STA can be legacy devices. Initially, some procedure, e.g. according to legacy approaches, is performed for requests for UL transmissions, and possible grant for these. Thus, the AP is aware that the NB STA will perform a UL transmission at least partly overlapping a UL transmission by the WB STA, and will therefore know that the NB STA UL transmission will interfere with the WB STA UL transmission. The AP determines from this how much increased robustness in coding, i.e. adaptation of modulation and coding scheme (MCS), is needed for proper reception and decoding of the WB STA UL transmission compared with if no interference would be present. The AP communicates an MCS suggestion accordingly to the WB STA, which preferably selects MCS accordingly for the UL transmission. The AP may also transmit a suggestion on a resource unit (RU) to use to the NB STA wherein the NB STA selects a RU to use accordingly, but this is only in the case the AP and NB STA are arranged to operate in such way. The NB STA can as well operate on an autonomous way or according to a predetermined scheme, wherein the RU selection is made entirely in the NB STA. The WB STA and the NB STA then perform their UL transmissions, and the AP receives and decodes the transmissions.

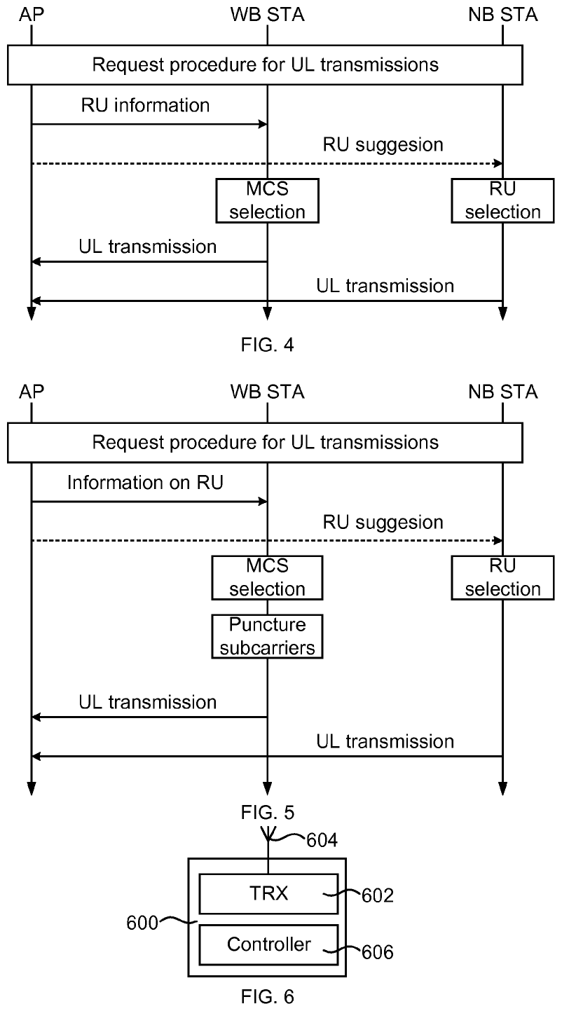

FIG. 4 is a signal scheme illustrating operation according to an embodiment. In this embodiment, the AP and the WB STA need to have features as described herein, while the NB STA can be a legacy device. Initially, some procedure, e.g. according to legacy approaches, is performed for requests for UL transmissions, and possible grant for these. Thus, the AP is aware that the NB STA will perform a UL transmission at least partly overlapping a UL transmission by the WB STA, and will therefore know that the NB STA UL transmission will interfere with the WB STA UL transmission. The AP will communicate information about this to the WB STA.

The information includes information about what resource units are expected to be interfered by NB STAs, i.e. which subcarriers, one or more sets depending on if it is one or more NB STAs involved, are affected. Thus, the WB STA will select a suitable MCS for the UL transmission based on this and other information, e.g. about the channel.

The information may for example also include an MCS suggestion as demonstrated with reference to FIG. 3, i.e. the AP determines from this how much increased robustness in coding, i.e. adaptation of modulation and coding scheme (MCS), is needed for proper reception and decoding of the WB STA UL transmission. The WB STA may consider this suggestion, or make the MCS selection without considering the MCS suggestion.

The AP may also transmit a suggestion on a resource unit (RU) to use to the NB STA wherein the NB STA selects a RU to use accordingly, but this is only in the case the AP and NB STA are arranged to operate in such way. The NB STA can as well operate on an autonomous way or according to a predetermined scheme, wherein the RU selection is made entirely in the NB STA.

The WB STA and the NB STA then perform their UL transmissions, and the AP receives and decodes the transmissions.

FIG. 5 is a signal scheme illustrating operation according to an embodiment. In this embodiment, the AP and the WB STA need to have features as described herein, while the NB STA can be a legacy device. Initially, some procedure, e.g. according to legacy approaches, is performed for requests for UL transmissions, and possible grant for these. Thus, the AP is aware that the NB STA will perform a UL transmission at least partly overlapping a UL transmission by the WB STA, and will therefore know that the NB STA UL transmission will interfere with the WB STA UL transmission. The AP will communicate information about this to the WB STA. The information includes information about what resource units which are expected to be interfered by NB STAs, i.e. which subcarriers, one or more sets depending on if it is one or more NB STAs involved, which are affected. As of the embodiment demonstrated with reference to FIG. 4, the WB STA will select a suitable MCS for the UL transmission.

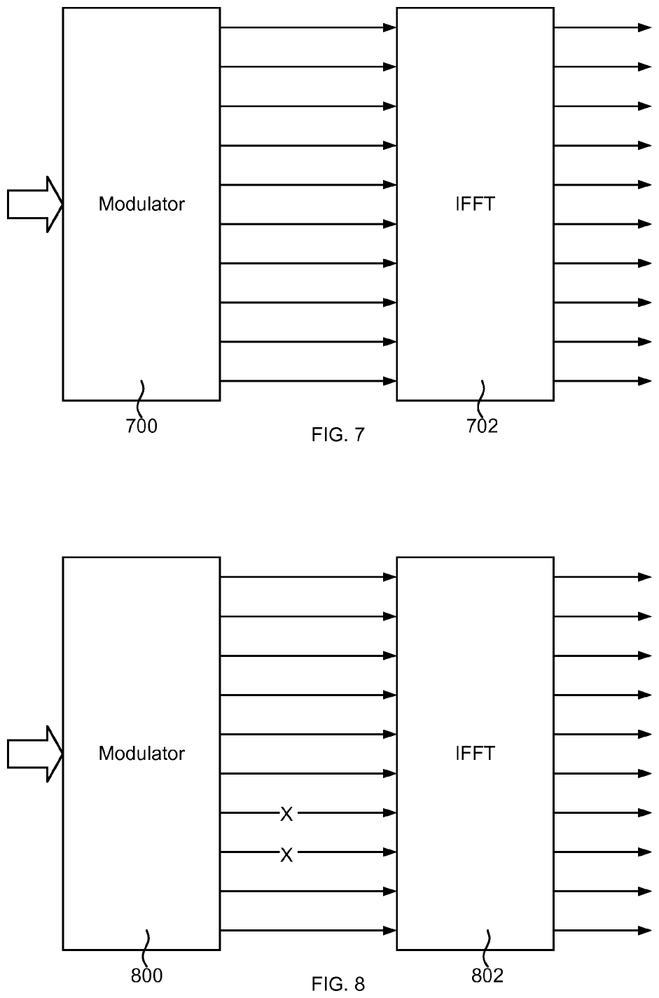

The information transmitted on the interfered subcarriers will likely not be successfully decoded at the AP, but this is dealt with by the more robust coding scheme used, where e.g. interleaving of information among the subcarriers is used. However, with the assumption that these subcarriers do not really convey any information, the WB STA may omit transmitting them. This may save power, reduce overall interference in the system in general, and interference affecting the NB STA communication in particular. Thus, it is suggested that the WB STA nulls the information related to the set of subcarriers which is expected to be interfered by the NB STA. For the understanding of this an example is provided with reference to FIGS. 7 and 8. FIG. 7 illustrates a modulator 700 which receives an information stream, illustrated by wide arrow to the left in FIG. 7, and provides symbols to an inverse fast Fourier transformer (IFFT) 702 which forms the actual subcarriers. This approach is widely used for orthogonal frequency division access (OFDMA) systems. FIG. 8 illustrates a modulator 800 which provides symbols to an IFFT 802, but where symbols corresponding to the subcarriers expected to be interfered by the NB STA are set to zero, as indicated in FIG. 8 by being crossed out. The transmission is thus formed accordingly.

The WB STA and the NB STA then perform their UL transmissions, and the AP receives and decodes the transmissions.

FIG. 6 is a block diagram schematically illustrating a wireless device 600 according to embodiments. FIG. 6 is, for the parts relevant for this disclosure, applicable both for an AP and a STA. The wireless device 600 comprises a transceiver 602 which is connected to an antenna arrangement 604. The transceiver 602 comprises hardware such as filters, amplifiers, etc. but may also comprise processing means. The wireless device further comprises a controller 606, which may be implemented as one or more processors. One or more processors of the transceiver 602 and the controller 606 may be at least partly joint.

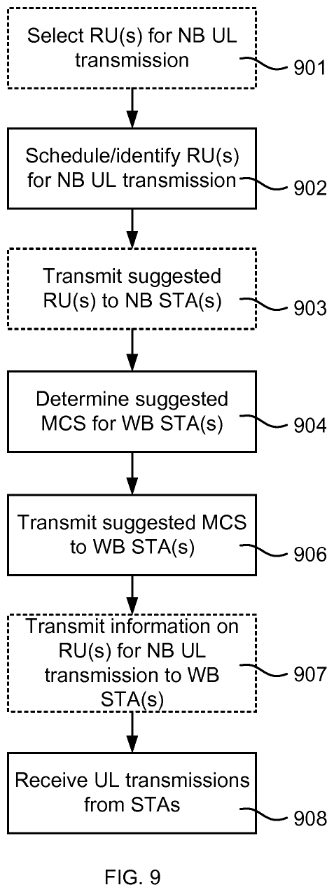

FIG. 9 is a flow chart illustrating a method of an AP according to embodiments. As demonstrated above with reference to FIGS. 3 to 5, it is assumed that some request procedure for UL transmissions have been performed according to standards of the applicable access networks. The AP schedules or identifies 902 one or more RUs which are to be used for UL transmissions by NB STAs, i.e. one or more sets of subcarriers. Here, “schedules” is for the case the AP decides the RU and “identifies” is for the case where another entity decides the RU. In any case, the AP will be aware of the one or more RUs which will be affected by NB STA UL transmissions.

Optionally, for the case where the AP decides the RU for NB UL transmission, the AP may select 901 the one or more RUs for the NB STA UL transmissions, which for example may be made such that subcarriers on which the channel from the WB STA is bad anyway. For example, the channel properties for the subcarriers used by the WB STA may be determined, and sets of subcarriers which are usable for NB UL transmissions are ranked, wherein the set of subcarriers having the worst channel properties is chosen 901 and scheduled 902 for NB UL transmissions.

Furthermore, for the case where the AP decides the RU for NB UL transmission, the AP transmits 903 information about the scheduled RU to the NB STA.

The AP has knowledge about the at least likely subcarriers which will be interfered by NB STA UL transmissions among the subcarriers to be used for WB STA UL transmissions. The AP thus determines 904 an MCS which is likely to withstand such interference. The determination 904 may comprise determining other noise and interference for the channel from the WB STA and add to this the expected interference caused by the likely NB UL transmission, and from this noise and interference picture map to a suggested MCS. The suggested MCS is transmitted 906 to the WB STA. Optionally, information about one or more RUs which are to be used for NB UL transmission is transmitted 907 to the WB STA.

The actions demonstrated above are applicable for one or more NB STAs and for one or more WB STAs involved in the UL transmissions. The AP is then able to receive 908 UL transmissions from the STAs, i.e. both NB and WB STAs.

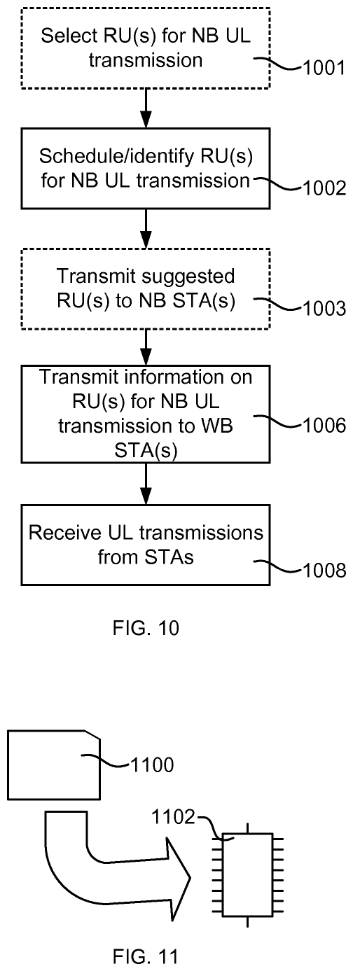

The method according to the different embodiments demonstrated with reference to FIG. 9 is based on the AP determining a suitable MCS for the WB STA. However, the determination of a suitable MCS may be put on the WB STA, as will be demonstrated with reference to FIG. 10 which is a flow chart illustrating a method of an access point according to an embodiment.

As demonstrated above with reference to FIGS. 3 to 5, it is assumed that some request procedure for UL transmissions have been performed according to standards of the applicable access networks. The AP schedules or identifies 1002 one or more RUs which are to be used for UL transmissions by NB STAs, i.e. one or more sets of subcarriers. Here, “schedules” is for the case the AP decides the RU and “identifies” is for the case where another entity decides the RU. In any case, the AP will be aware of the one or more RUs which will be affected by NB STA UL transmissions.

Optionally, for the case where the AP decides the RU for NB UL transmission, the AP may select 1001 the one or more RUs for the NB STA UL transmissions, which for example may be made such that subcarriers on which the channel from the WB STA is bad anyway. For example, the channel properties for the subcarriers used by the WB STA may be determined, and sets of subcarriers which are usable for NB UL transmissions are ranked, wherein the set of subcarriers having the worst channel properties is chosen 1001 and scheduled 1002 for NB UL transmissions.

Furthermore, for the case where the AP decides the RU for NB UL transmission, the AP transmits 1003 information about the scheduled RU to the NB STA.

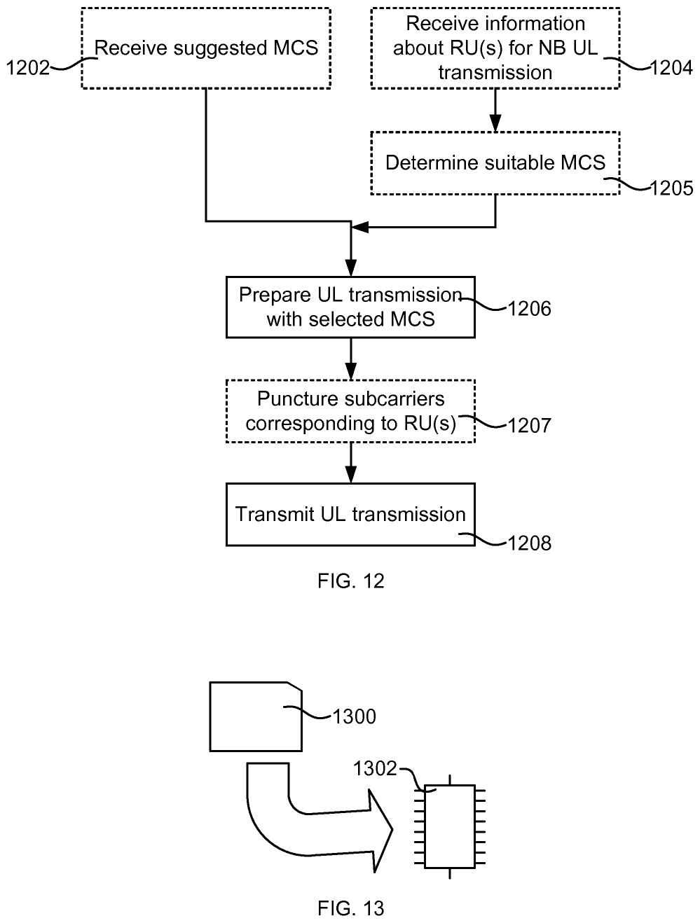

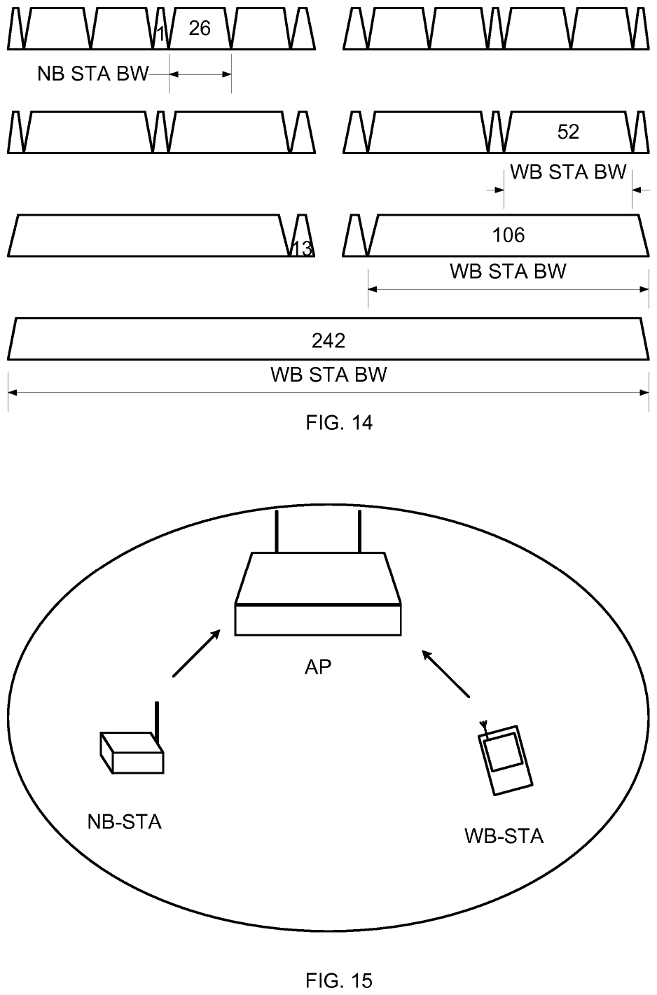

The AP has knowledge about the at least likely subcarriers which will be interfered by NB STA UL transmissions among the subcarriers to be used for WB STA UL transmissions. The AP thus transmits 1006 information to the WB STA about one or more RUs to be used for NB UL transmissions. As will be demonstrated with reference to FIG. 12, the WB STA is then able to take actions accordingly. The AP is then able to receive 1008 UL transmissions from the STAs, i.e. both NB and WB STAs.

The information, whether being suggested MCS and/or information about used NB UL RUs, can be sent in a separate packet, or as part of a header to a control packet. Alternatively, the WB STA can learn this information by monitoring the channel itself, or, it can be known that NB transmission always occurs. The MCS selection algorithm may be self-learning, i.e. a model for the MCS selection based on the knowledge about the NB UL transmissions may be updated based on successful or less successful previous adaptations.

The methods according to what demonstrated above is suitable for implementation with aid of processing means, such as computers and/or processors, especially for the case where the controller 606, and possibly also the transceiver 602, of the AP demonstrated above comprises a processor handling proper assignment of MCS. Therefore, there is provided computer programs, comprising instructions arranged to cause the processing means, processor, or computer to perform the steps of any of the methods according to any of the embodiments described with reference to FIGS. 1 to 10. The computer programs preferably comprise program code which is stored on a computer readable medium 1100, as illustrated in FIG. 11, which can be loaded and executed by a processing means, processor, or computer 1102 to cause it to perform the methods, respectively, according to embodiments of the present disclosure, preferably as any of the embodiments described with reference to FIGS. 1 to 10. The computer 1102 and computer program product 1100 can be arranged to execute the program code sequentially where actions of the any of the methods are performed stepwise, but may as well be arranged to perform actions according to a real-time procedure. The processing means, processor, or computer 1102 is preferably what normally is referred to as an embedded system. Thus, the depicted computer readable medium 1100 and computer 1102 in FIG. 11 should be construed to be for illustrative purposes only to provide understanding of the principle, and not to be construed as any direct illustration of the elements.

As demonstrated above, the WB STA may be arranged to receive an MCS suggestion or determine a suitable MCS itself from information about RUs used for NB UL transmissions, and the WB STA may be arranged to apply an adapted MCS directly or also perform nulling of symbols corresponding to subcarriers which are used for and thus interfered by NB UL transmissions. FIG. 12 is a flow chart illustrating a method of a wideband wireless station according to embodiments where the different options are included.

As demonstrated above with reference to FIGS. 3 to 5, it is assumed that some request procedure for UL transmissions have been performed according to standards of the applicable access networks. The WB STA receives 1202 a suggested MCS and/or receives 1204 information about RUs where NB UL transmissions are likely to occur. For the case where the WB STA has received information about the RUs, the WB STA may determine 1205 a suitable MCS, which may be performed in a similar way as demonstrated above for the AP.

The WB STA prepares 1206 UL transmissions applying selected MCS. Possibly, the WB STA punctures subcarriers corresponding to the RUs, e.g. symbols corresponding to subcarriers likely or known to be interfered by NB UL transmissions are set to zero. The UL transmission is then transmitted 1208.

The methods according to what demonstrated above is suitable for implementation with aid of processing means, such as computers and/or processors, especially for the case where the controller 606, and possibly also the transceiver 602, of the WB STA demonstrated above comprises a processor handling proper assignment of MCS. Therefore, there is provided computer programs, comprising instructions arranged to cause the processing means, processor, or computer to perform the steps of any of the methods according to any of the embodiments described with reference to FIGS. 1 to 8 and 12. The computer programs preferably comprise program code which is stored on a computer readable medium 1300, as illustrated in FIG. 13, which can be loaded and executed by a processing means, processor, or computer 1302 to cause it to perform the methods, respectively, according to embodiments of the present disclosure, preferably as any of the embodiments described with reference to FIGS. 1 to 8 and 12. The computer 1302 and computer program product 1300 can be arranged to execute the program code sequentially where actions of the any of the methods are performed stepwise, but may as well be arranged to perform actions according to a real-time procedure. The processing means, processor, or computer 1302 is preferably what normally is referred to as an embedded system. Thus, the depicted computer readable medium 1300 and computer 1302 in FIG. 13 should be construed to be for illustrative purposes only to provide understanding of the principle, and not to be construed as any direct illustration of the elements.

A few tangible examples will be given below for better understanding of application of the approaches in exemplary systems. First, an example will be given in the context of transparent overlaid UL transmission, and second, an example with overlaid UL transmission with selective blanking is given.

In the first example, the AP schedules both an IEEE 802.11ax UL transmission and NB-WiFi transmission in the same time slot in a 20 MHz channel. The bandwidth of the NB-WiFi may for instance fit exactly in the smallest size RU, but its bandwidth may be smaller or larger without impacting the working procedure of this example.

Since an 802.11ax transmission from a single STA must use a RU size of 26, 52, 106 or 242 sub-carriers and the NB-WiFi is assumed to have a bandwidth corresponding to the smallest RU, i.e., 26 sub-carriers, using plain OFDMA would mean that IEEE 802.11ax would be allocated to a 106 sub-carrier wide RU, NB-WiFi would be allocated to a 26 sub-carrier wide RU, and effectively a 106 sub-carrier wide RU would be unused, i.e., wasted.

According to the first example, the wideband STA is instead scheduled to use the largest RU, i.e., the 242 sub-carrier wide RU and the NB-WiFi STA is scheduled somewhere within this bandwidth. As an example, the NB-WiFi STA may be scheduled to use one of the 26-sub-carrier RUs. In addition to schedule the 802.11ax STA to use the largest RU, the AP also decides what MCS should be used. Now, since the NB-WiFi STA is scheduled to use a small part of the RU allocate to the IEEE 802.11ax STA, the AP takes this into account when selecting what MCS should be used for the IEEE 802.11ax STA. As an example, if the preferred MCS without interference would have been, say, 16-QAM and a rate 0.75 code, the AP may instead decide that wideband IEEE 802.11ax STA should use 16-QAM and a rate 0.5 code to account for that a small part of the received wideband signal will suffer severely from interference.

Thus, the gist is that the AP can determine how much degradation the narrow band transmission will result in, and adjust the MCS accordingly. There may be situations when the AP will be able to easily demodulate the narrowband signal and then subtract the interference from the wideband signal, in which case it may be possible to use the same MCS as if there would have been no narrowband interference at all.

The demodulation at the AP may also be performed in the opposite order, i.e., the AP may select to first demodulate the wideband signal, and based on the outcome regenerate the received signal coming from the wideband transmitter and then subtract this from the totally received signal to effectively subtract the interference caused to the narrowband signal.

In the second example, the wideband STA is made aware of that part of the bandwidth will be used by another user, and is therefore requested to null out the corresponding sub-carriers. The number of sub-carriers requested to be nulled out may or may not correspond to a specific RU. By requesting the wideband STA to not send any data on the sub-carriers that will be used by the narrowband STA, the interference from the wideband signal to the narrowband signal is significantly reduced, thus typically improving the reception of the narrowband signal at the AP.

Feasibility to overlay a narrowband IoT signal in IEEE 802.11 will here be discussed with reference to FIGS. 15 to 27 including a bundle of non-limiting examples.

The case where a narrowband signal, intended for IoT applications, is transmitted concurrently with legacy Wi-Fi signal by means of overlay is studied. Concurrent operation is seen as a means to achieve high spectral efficiency in the future Internet of Things (IoT) society. In addition, it allows for a relatively simple means to support a narrowband signal that can be made to coexist with legacy devices. The performance is studied for the up-link under various assumptions for both the transmitter and the receiver. Although the approach works without any modifications of the legacy transceiver, it is here shown that by minimal modifications of the legacy Wi-Fi receiver, significant gains for the wideband transmission can be achieved. Furthermore, if also the wideband transmitter is aware of the narrowband transmitter, small modifications can improve the performance of the narrowband transmission.

Wireless standards addressing IoT include Bluetooth Wireless Technology, Zigbee, and Sigfox. Currently, there has not been so much improvements in Wi-Fi 802.11 technologies for good IoT support in the 2.4 GHz ISM band and the 5 GHz bands. However, IoT support within 802.11 may be achieved by using a considerably narrower bandwidth than the 20 MHz which is the smallest bandwidth supported in e.g. 802.11n and 802.11ac. IEEE 802.11 are currently developing an amendment, 802.11ax, which supports new features that are usually supported only in licensed bands. Examples of such features are for instance Orthogonal Frequency Division Multiple Access (OFDMA), both for uplink (UL) and downlink (DL). With the introduction of OFDMA in 802.11ax, the smallest bandwidth that can be allocated to a station (STA) is about 2 MHz. Although OFDMA in principle allows for multiplexing a narrow-band user with wide-band users by sharing the bandwidth, the ways resource units (RUs) can be allocated in 802.11ax is limited, and in addition devices only supporting 802.11n and 802.11ac would not be able to use this approach.

Here, a scenario is considered where a 20 MHz 802.11ax system (here, referred to as WB-WiFi system) coexists with a 2 MHz OFDM system (here, referred to as NB-WiFi), but where the channel is shared by means of overlay rather than OFDMA. This approach would then in principle be applicable also for IEEE 802.11n and IEEE 802.11ac. In particular, the up-link (UL) case is studied, where a WB-WiFi STA and NB-WiFi STA both transmit data to the access point (AP) concurrently. This is illustrated in FIG. 15. Such a transmission is here referred to as an overlay transmission because the NB signal can be considered to be overlaid on the WB signal. First, using overlay, the case where the WB STA is a legacy 802.11ax STA is considered. At the AP, when decoding the WB signal, two cases are considered: overlay-unaware decoding and overlay-aware decoding. When using overlay-unaware decoding, the AP performs decoding without using any knowledge of the interfering signal from the NB STA, while in the overlay-aware decoding, special methods to improve the decoding performance are considered. Second, the case where the WB STA alleviates for the NB STA by blanking the parts of the transmitted signal where the NB signal will be transmitted is considered. By simulation results, it has been concluded that the these relatively simple modification needed for enhanced co-existence significantly improve the performance for concurrent transmission, enabling good spectrum efficiency.

Below there will be described some preliminaries and system model, methods for the signal communication, simulation results and, finally, conclusions.

Below, the discussion uses 802.11ax numerology as the WB system. There are several mechanisms present in the 802.11ax amendment that are interesting:

1) Basic Numerology: In the 802.11ax amendment, multiple BW options are available. Here, focus is on the default channel BW of 20 MHz. In the preamble, legacy and signalling fields are defined using a 64-point inverse fast Fourier transform (IFFT), providing a sub-carrier spacing of 20/64 MHz=312.5 kHz. After that, the high efficiency (HE) training fields HE-STF and HE-LTF comes, followed by the data part, all which are generated using a 256-point IFFT. The subcarrier spacing of this part thus becomes 20/256 MHz=78.125 kHz, and the duration of one OFDM symbol is 256/20 us=12.8 μs, not including the guard interval (GI) (the term guard interval and cyclic prefix are used interchangeably referring to the same thing).

2) Orthogonal Frequency Division Multiple Access: The Orthogonal Frequency Division Multiple Access (OFDMA) support in 802.11ax standard provides a certain flexibility in the selection of the bandwidth used. On one hand, the 802.11ax amendment allows to transmit on 20, 40, 80 and 160 MHz channels. On the other hand, each channel can be divided in resource units (RUs) of different sizes. In the case of a 20 MHz channel, there are four sizes for a RU, corresponding to bandwidths of roughly 2, 4, 8, and 18 MHz (the last corresponding to use of the full channel). These are depicted in FIG. 15. The 2 MHz RU has 26 subcarriers available. A STA may be allocated either one 26 sub-carrier RU, one 52 sub-carrier RU, one 106 sub-carrier RU, or the full bandwidth which corresponds to 242 sub-carriers. Note that when using OFDMA in 802.11ax, if one STA is assigned one RU of 2 MHz, the largest non-overlapping RU a second STA can be assigned is 8 MHz.

3) Access Point Scheduling using Trigger Frame: In the 802.11ax amendment, the AP may schedule uplink multi-user (MU) transmissions by sending a Trigger frame (TF). The TF contains scheduling information (RU allocations and modulation and coding scheme, MCS) for each STA. The TF also serves the purpose of providing time synchronization (the UL transmission starts after a predetermined time delay, SIFS, after the TF).

Here, a typical OFDM receiver chain using a soft decoder is considered. A simplified version of such a receiver chain is depicted in FIG. 17. The waveform r(t) is received. Then, with the equalization box, it is referred to that detection, synchronization, FFT, channel estimation, and equalization are all performed to get the modulated symbols sₙ. These symbols sₙ are then demodulated using a soft demodulator to get log likelihood ratios LLRₘ. These LLR's are then used by the decoder to decode the data bitstream bm.

Herein, the UL scenario where a NB-STA and WB-STA transmit concurrently is considered. The numerology of the 802.11ax amendment is still used, but equivalent results may be obtained using other numerologies. The WB-STA will be allocated the largest RU corresponding to the full BW (i.e., 242 subcarriers), and the NB-STA will be allocated the smallest RU corresponding to 2 MHz (i.e., 26 subcarriers). This is depicted in FIG. 18. OFDMA to multiplex the WB-STA and the NB-STA is not used here for two reasons: First, in case of 802.11ax, it is inherently spectrum limited by the fact that if one STA is assigned one RU of 2 MHz, the largest non-overlapping RU a second STA can be assigned is 8 MHz. Second, most WB-STA's currently present in the market, e.g. 802.11n or 802.11ac do not support OFDMA.

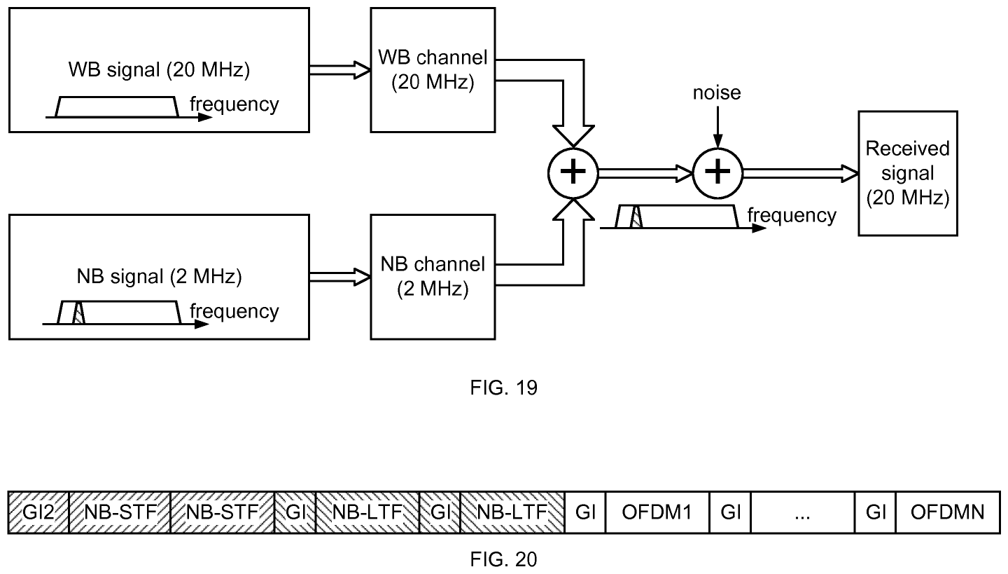

FIG. 19 shows the basic signal processing operation in the system simulator at hand. The two STAs create respective signals occupying 20 MHz (WB) and 2 MHz (NB). The NB signal is up-sampled to 20 MHz to enable processing with the WB signal. The two signals are passed through two independent channels, referred to as the NB and WB channel, respectively. In the receiver, receiver noise may be finally added. The transmissions are triggered by a TF from the AP, and good synchronization is therefore assumed. Details of the simulation will be elucidated below, and also below methods for improving performance for both the NB and WB transmission will be elucidated.

In a common case, the WB STA is allocated a larger bandwidth, e.g., the whole 20 MHz channel for its UL transmission. The NB STA is instead allocated a fraction of the bandwidth used by the WB STA, e.g., a 2 MHz overlapped with the WB channel. The two UL signals transmitted by the WB and NB STAs on the same RU interfere with each other at the AP. A number of methods for improved NB and WB signal overlay in the UL are proposed. To help the reader better follow the ideas, terminology used are listed to describe the methods.
Overlay Transmission: A transmission where one or two signals are transmitted simultaneously. Typically, the transmissions take place on overlapping frequency bands, but they may in some cases be orthogonal.
Puncture: After signal demodulation, a receiver chain that knows certain subcarriers are unreliable may puncture these subcarriers. In a soft demodulator, this typically refers to setting the log likelihood ratios (LLR's) of the affected bits to 0.
NB Aware: The AP WB receiver chain is said to be NB-aware when it knows that on certain subcarriers the WB signal is interfered concurrent by NB transmissions. A NB aware WB receiver chain in the AP may e.g. puncture the subcarriers used by the NB transmission.
NB Unaware: The AP WB receiver chain is said to be NB-unaware when it does not know that certain subcarriers are interfered by concurrent NB transmissions.
Blanking: A WB-STA that knows that some subcarriers will be used by a NB-STA alleviates the NB-STA transmission by assigning zeros to those subcarriers.

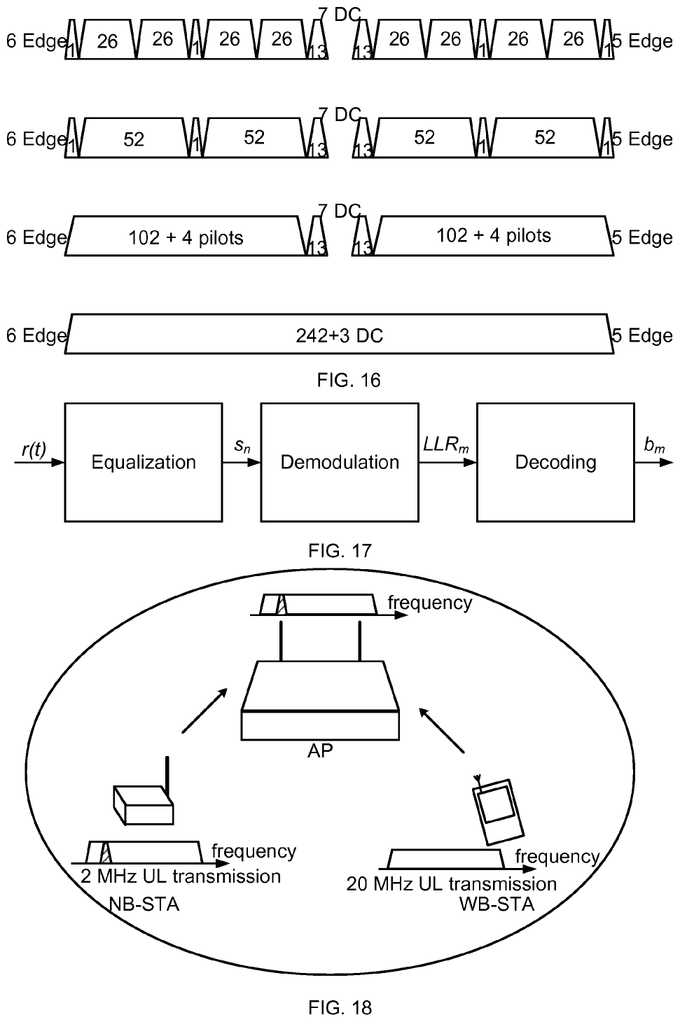

The packet design of the NB signal will now be considered. Referring back to FIG. 16, it can be seen that the 2 MHz RU's each has 26 subcarriers. Out of these subcarriers, two are assigned as zeros; One for the DC carrier and one for guard against adjacent bands. Of the remaining 24 active subcarriers, it is proposed to use two subcarriers for pilots. The size of the guard interval (GI) for the OFDM symbols has the same length as the GI for the WB system. In 802.11ax, this means either 0.8 μs, 1.6 μs, or 3.2 μs.

There may be potential NB receivers, so for the packet format, the NB signal is assumed to contain a short training field (STF), long training field (LTF), followed by the Signal and Data field using traditional OFDM symbols. The NB packet format is depicted in FIG. 20. In this figure, GI2 represents a GI to the full STF field which is two times the length of a standard GI. To define the STF and LTF, the frequency domain representations are used, where the centre of frequency for a specific RU is located at subcarrier 0. The STF is reused as defined by the 1M packet format for the 802.11ah amendment. It is defined in frequency domain as:

$$STF = \frac{1 + j}{\sqrt{2 / 3}} [ 0.5 , - 1 , 1 , - 1 , - 1 , - 0.5 ] ,$$

for subcarriers k=[−12, −8, −4, 4, 8, 12], respectively. For the LTF, re-use of the LTF defined by the 1M packet format for the 802.11 ah amendment may also be made. This LTF is however slightly too wide, which may be handled by removing 2 subcarriers. This can then be represented in the frequency domain as:
LTF=[−1, 1, −1, −1, 1, −1, 1, 1, −1, 1, 1, 1, 0, −1, −1, −1, 1, −1, −1, −1, 1, −1, 1, 1, 1], for subcarriers −12 to 12.

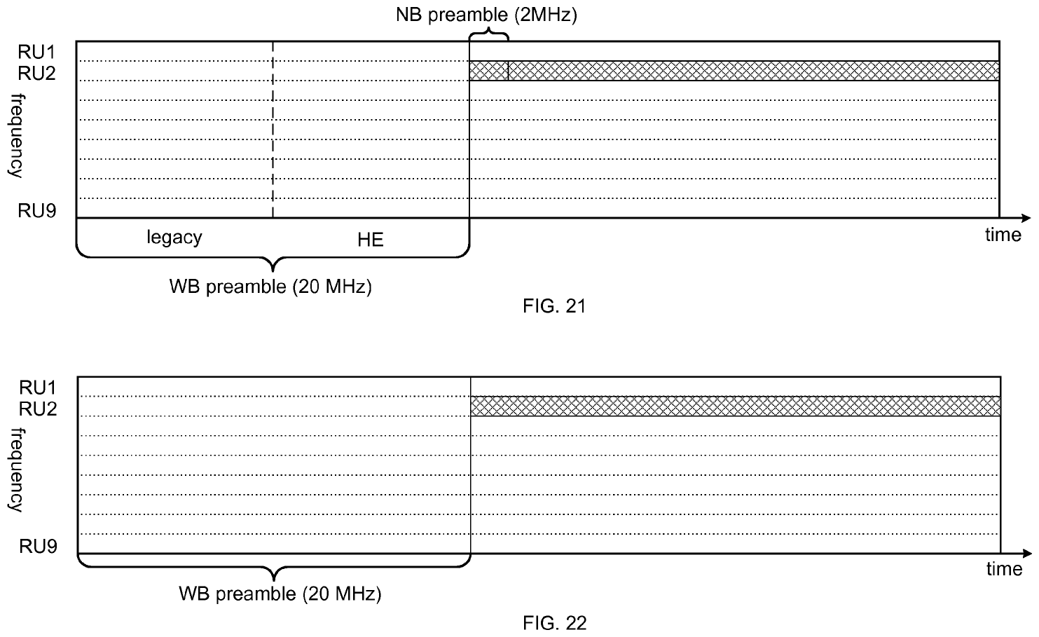

Using the TF, the NB-STA and WB-STA may synchronize their transmissions. FIG. 21 shows an example of packet structure for the UL transmission studied herein. The NB-STA is scheduled to start transmitting after the WB preamble of the WB-STA. In FIG. 21, the NB-STA is allocated RU 2. The WB preamble comprises both a legacy and a High Efficiency (HE) preamble, serving different purposes not of interest here. Recall that the legacy preamble is computed using a 64-point IFFT, while the HE preamble uses a 256-point IFFT, as the rest of the packet. In turn, the NB packet entails first a NB preamble and then the NB data field, both using 2 MHz. Three different cases with respect to the time synchronization between WB and NB signals are elucidated here:
1) the NB signal is overlaid completely (i.e., starts at the same time) with the WB signal,
2) the NB signal is overlaid partially with the WB preamble, i.e., the NB signal starts after the legacy preamble,
3) the NB signal starts after the whole WB preamble (example in FIG. 21).

The AP is always aware of which RU is used by the NB signal (RU 2 in FIG. 21) as the AP itself has previously scheduled NB STA there. The AP can therefore use different decoding approaches and techniques. Note that in 2) and 3) above, since the NB and WB both use OFDM with the same subcarrier spacing, and they are time synchronized, orthogonality among different subcarriers is preserved.

The WB signal reception at the AP will now be discussed, i.e., how the AP decodes the WB desired signal in FIG. 19. The decoding of the NB signal will be elucidated below.

First, the case where the AP is unaware about the NB transmission is considered. This means that the WB receiver chain may be able to recover parts of the WB signal interfered by the NB signal. In the case where the NB signal overlaps with the preamble of the WB signal, synchronization and channel estimation performance for the WB system degrade. Therefore, better performance is expected if the NB signal is placed after the WB preamble. This is illustrated in FIG. 21. Note that regardless of where the NB signal is placed with respect to the WB signal, the NB signal will be orthogonal to the WB signal.

Second, by considering a case where the AP is aware of the NB transmission, more sophisticated techniques for signal recovery may be considered. One such example is to let the WB receiver chain perform puncturing of the subcarriers interfered by the NB signal. Referring to FIG. 17, puncturing to set the LLR's corresponding to the affected bits to 0 is considered.

Since the interference from the NB signal is only over about 10% of the subcarriers for the WB signal, the performance of the WB signal recovery is expected to be good, specifically for higher code rates.

The performance of the NB signal is now elucidated. Note that when the NB signal is placed on top of the 64-point FFT part of the WB preamble, additional interference from the WB preamble will occur on the NB signal due to the larger subcarrier spacing of the WB signal. Therefore, the NB performance is expected to be better if the NB signal is placed after the 64-point FFT preamble. For the WB decoding, the fact that only a small part of the WB signal was interfered by the NB signal may be advantageous. In the case of NB decoding however, the whole signal will be interfered by the WB signal.

First, the case that the NB signal is completely overlaid on the WB signal will be considered. For NB signal decoding, it is therefore relied on good signal-to-interference (SI) properties to the WB signal for decoding.

Second, a more advanced scheme is considered, where the WB-STA is aware of the concurrent transmission of the NB-STA. It is assumed that this information can either be obtained by the AP or inferred by other means. If that is the case, the WB-STA can perform blanking on the RU occupied by the NB station to increase the SI properties of the NB signal. In fact, when the subcarriers are orthogonal, if blanking is performed correctly, there will be no WB interference on the RU used by the NB-STA.

Above, simple approaches to improve the performance of both NB and WB transmission have been considered. A more advanced method that could help signal reception, even without need for blanking, is Successive Interference Cancellation (SIC), as for example mentioned in N. I. Miridakis and D. D. Vergados, “A Survey on the Successive Interference Cancellation Performance for Single-Antenna and Multiple-Antenna OFDM Systems”, published in IEEE Communication Surveys & Tutorials, Vol. 15, No. 1, First Quarter 2013, which is hereby incorporated by reference. The key idea of SIC is that users are decoded successively. After one user is decoded, its signal is stripped away from the aggregate received signal before the next user is decoded. When SIC is applied, one of the users, say WB users, is decoded treating the NB as interference, but NB is decoded with the benefit of the WB signal already removed. As discussed before, using conventional reception every user is decoded treating the other interfering user as noise. The drawback of using SIC is a need to wait for one signal to be fully decoded before decoding the next signal. It will therefore be difficult for a traditional receiver to reply with an ACK within the standardized time.

Simulation results will now be discussed. To start with, the simulation setup and definition of some parameters will be discussed. For this, a simulation setup has been developed where a WB device generates a 20 MHz signal using a 256-FFT. In the simulation, the WB-STA is in fact an 802.11ax STA. The NB is generated using a 32-point FFT, but such that only 24 of the subcarriers are non-zero. Two independent channels for the signals generated by the WB and the NB devices, where besides the AWGN channel, the TGn channel models are used. Results for different modulation and coding schemes for the WB-STA are shown.

In the simulations, the relation between the NB signal strength and the WB signal strength is characterized with the Signal-Interference-Ratio (SIR).

$$SIR = 20 {log}_{10} \frac{E \{ {‖ {r}_{WB} ( t ) ‖}_{2} \}}{E \{ {‖ {r}_{NB} ( t ) ‖}_{2} \}} ,$$

where r_{WB}(t) and r_{NB}(t) are the received signals. The SIR is varied by changing the signal power of the NB signal. The way the SIR is defined, the received power spectrum density is nearly flat at SIR=10 dB. When SIR=0 dB, the NB signal is very strong compared with the WB signal. The STA's are placed in an equivalent environment at the same distance from the AP. The packet error rate (PER) is used to evaluate the performance.

In most simulations, a simple SISO system is used, but also the performance when the WB-STA has access to two spatial streams is evaluated.

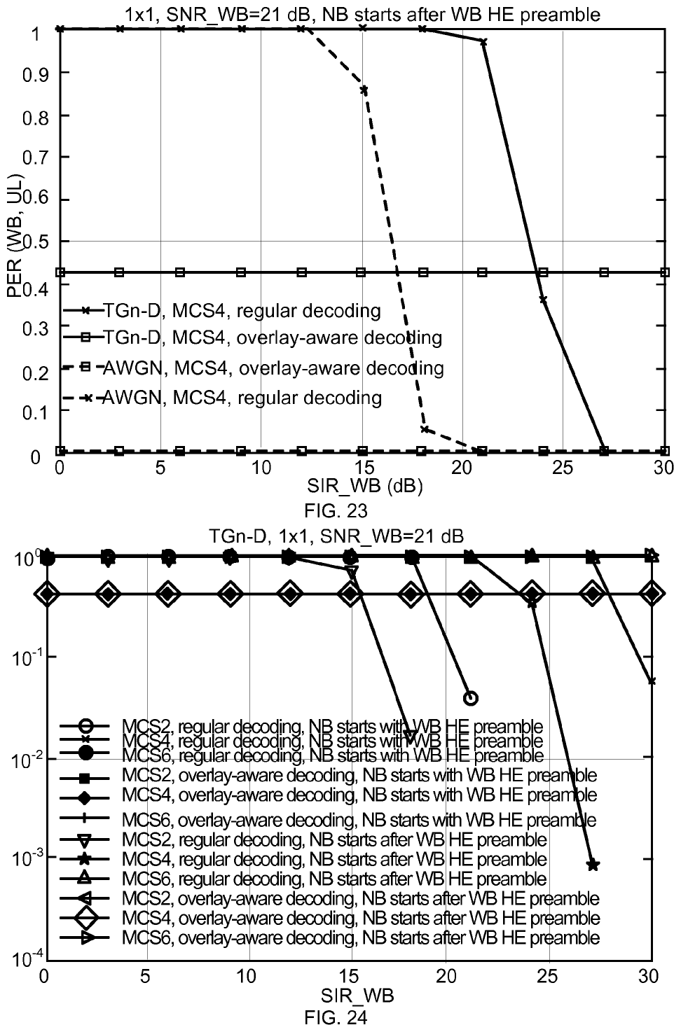

In FIG. 23, focus is on the performance of the WB signal, by showing PER versus SIR. Here, the SNR is fixed for the WB STA to 21 dB, the MCS for the WB STA is 4. In this figure, a SISO system is used, the NB signal starts after the WB HE preamble (see FIG. 21). Two different channel models are considered: AWGN and TGn-D. As it can be seen for both channels the performance of overlay aware decoding is independent of the actual SIR (although an higher PER is obtained with TGn-D model). This happens because independent of the SIR level, the AP discards the information in RU of the NB device when decoding the WB signal. In FIG. 23 we also see that at very high SIR, the WB transmission is no longer harmed by the NB signal, as expected from the discussion above.

Similar to FIG. 23, FIG. 24 shows the PER vs. SIR where the WB signal has SNR 21 dB, TGn-D channel, UL SISO transmission, the NB signal starts either with or after the WB HE preamble, and a wide range of MCS's. From the figure, it is clear that the puncturing at the AP from the overlay-aware case provides the same performance independently of NB signal strength. It can also be seen that when no puncturing is performed, the performance of the WB system is better when the NB signal starts after the HE preamble. This is the case because channel estimation for the WB becomes better when the HE-LTF is not disturbed by the NB signal.

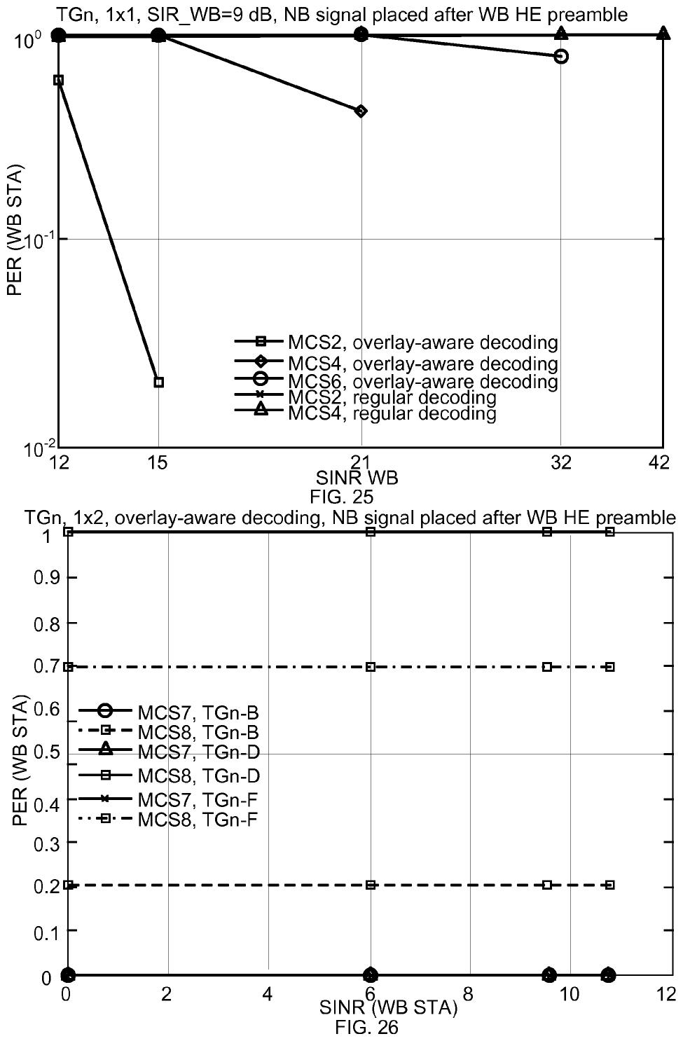

FIG. 25 shows PER vs. SNR with a fixed SIR at 9 dB, and the NB signal starting after the HE preamble. As expected from previous simulations, the overlay-aware decoding performs better than overlay-unaware decoding.

FIG. 26, shows that the puncturing performed by the AP in the overlay-aware case is robust to different channel models and also for multiple spatial streams. In particular there is shown the result when the WB signal use MCS 7 and 8, for TGn B, D and F, and with 2 spatial streams.

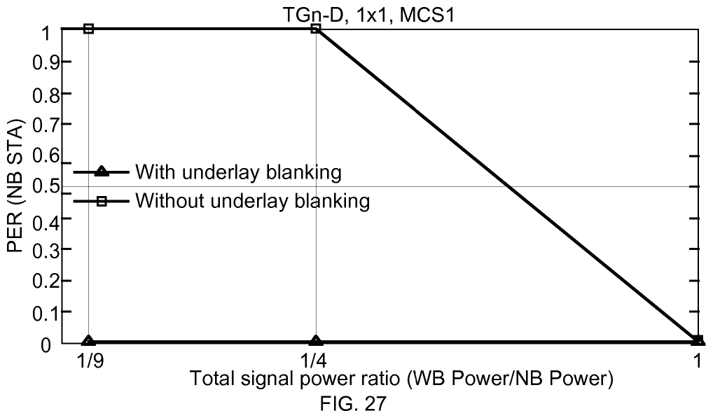

Finally, FIG. 27 shows the performance for the NB STA. The NB signal is encoded using MCS 1. When blanking is performed, the NB STA experience completely interference-free conditions from the WB. But even without blanking, we see that the NB STA can obtain decent performance.

From the above discussed study of coexistence between wideband and narrowband signals in uplink transmissions in IEEE 802.11ax WLANs, an overlay scenario has been considered where the NB signal overlays with the WB signal. Various decoding techniques have been investigated that could be applied at the AP for both WB and NB signal reception. The results elucidated above show for example that
For the WB performance, overlay-aware decoding clearly provides an advantage over regular decoding for the studied channels (TGn-B,D,G) and SINR ranges (0-15 dB).
In the studied SINR ranges, the overlay-aware performance is independent of the NB signal power.
With overlay-aware decoding it is possible to have a strong NB signal overlay and still operate the WB-STA at high rate.
The performance of overlay-aware decoding is unaffected by whether NB signal starts after WB preamble or along with HE-LTF of the WB preamble (at least in the studied ranges). However, if the NB signal also overlaps with the legacy preamble part of the WB signal orthogonality is lost and WB transmissions fail.
NB STA transmission can take place quite well with WB blanking. This is to show proof-of-concept. It can thus be concluded that NB and WB systems can with minimal modifications co-exist in a graceful manner.

1-29. (canceled)

30. An access point configured to serve both wideband wireless stations and narrowband wireless stations, where the narrowband wireless stations operate on a subset of the bandwidth on which the wideband wireless stations operate, the access point comprising:
a transceiver; and
a controller,
wherein the controller is configured to schedule simultaneous usage of a first set of subcarriers for a wideband station and a first narrowband wireless station by causing the transceiver to transmit a first subcarrier suggestion, about the first set of subcarriers to be used, to the first narrowband wireless station, and to transmit a modulation and coding scheme (MCS) suggestion, about subcarriers including the first set of subcarriers to be used, to the wideband station, and
wherein the suggested MCS is adapted to have increased robustness in view of any interference on a transmission from the wideband wireless station caused by a transmission from the first narrowband wireless station in the first set of subcarriers.

31. The access point of claim 30, wherein the controller is configured to schedule simultaneous usage of a second set of subcarriers for a second narrowband wireless station by causing the transceiver to transmit a second subcarrier suggestion about the second set of subcarriers to be used to the second narrowband wireless station, wherein the subcarriers used by the wideband wireless station includes the second set of subcarriers and the increased robustness of the suggested MCS is also adapted to be in view of any interference on a transmission from the wideband wireless station caused by a transmission from the second narrowband wireless station in the second set of subcarriers.

32. The access point of claim 30, wherein the MCS with increased robustness has increased robustness in view of an MCS that would have been used based on channel status of the wideband wireless station in absence of any interference from a narrowband wireless station.

33. The access point of claim 30, wherein a subcarrier suggestion to be used by a narrowband wireless station is selected among the subcarriers to be used by the wideband wireless station where channel status of the wideband wireless station is worse than for another of the subcarriers to be used by the wideband wireless station.

34. The access point of claim 33, wherein the selection of the suggested subcarrier is a subset of subcarriers of the subcarriers to be used by the wideband wireless station having the worst channel status and is not used by another narrowband wireless station.

35. The access point of claim 30, wherein the controller is configured to cause the transceiver to transmit to the wideband wireless station information about one or more subcarriers expected to be interfered by narrowband stations.

36. The access point of claim 35, wherein the information about the one or more subcarriers expected to be interfered by narrowband wireless stations is transmitted along with the MCS suggestion.

37. A wideband wireless station configured to operate under control of an access point configured to serve both wideband wireless stations and narrowband wireless stations where the narrowband wireless stations operate on a subset of the bandwidth on which the wideband wireless stations operate, the wideband wireless station comprising a transceiver and a controller, wherein
the transceiver is configured to receive a modulation and coding scheme (MCS) suggestion for the subcarriers to be used,
the controller is configured to control preparation of transmissions to the access point to be adapted based on the MCS suggestion, and
the transceiver is configured to transmit the prepared transmission.

38. The wideband wireless station of claim 37, wherein the transceiver is configured to receive information about one or more sets of subcarriers expected to be interfered by the narrowband wireless stations.

39. The wideband wireless station of claim 38, wherein the controller is configured to cause cancelling of subcarriers corresponding to the one or more sets of subcarriers expected to be interfered by the narrowband wireless stations.

40. The wideband wireless station of claim 38, wherein the information about the one or more sets of subcarriers expected to be interfered by the narrowband wireless stations is received from the access point.

41. The wideband wireless station of claim 38, wherein the information about the one or more sets of subcarriers expected to be interfered by the narrowband wireless stations is received by monitoring a channel between the access point and the wireless stations.

42. The wideband wireless station of claim 37, wherein the received suggested MCS comprises a MCS which is adapted to have increased robustness in view of any interference on a transmission from the wideband wireless station to the access point caused by transmissions from the narrowband wireless stations, wherein the applied MCS for the preparation of transmissions to the access point is the suggested MCS.

43. The wideband wireless station of claim 37, wherein the applied MCS for the preparation of transmissions to the access point is based on the received suggested MCS, but is adapted to have increased robustness in view of any interference on a transmission from the wideband wireless station to the access point caused by transmissions from the narrowband wireless stations.

44. A method of an access point which is configured to serve both wideband wireless stations and narrowband wireless stations where the narrowband wireless stations operate on a subset of the bandwidth on which the wideband wireless stations operate, the method comprising
scheduling simultaneous usage of a first set of subcarriers for a wideband station and a first narrowband wireless station;
transmitting a first subcarrier suggestion, about the first set of subcarriers to be used, to the first narrowband wireless station; and
transmitting a modulation and coding scheme, MCS suggestion, about subcarriers including the first set of subcarriers to be used, to the wideband station, wherein the suggested MCS is adapted to have increased robustness in view of any interference on a transmission from the wideband wireless station caused by a transmission from the first narrowband wireless station in the first set of subcarriers.

45. The method of claim 44, comprising:
scheduling simultaneous usage of a second set of subcarriers for a second narrowband wireless station; and
transmitting a second subcarrier suggestion about the second set of subcarriers to be used to the second narrowband wireless station, wherein the subcarriers used by the wideband wireless station includes the second set of subcarriers and the increased robustness of the suggested MCS is also adapted to be in view of any interference on a transmission from the wideband wireless station caused by a transmission from the second narrowband wireless station in the second set of subcarriers.

46. The method of claim 44, wherein the MCS with increased robustness has increased robustness in view of an MCS that would have been used based on channel status of the wideband wireless station in absence of any interference from a narrowband wireless station.

47. The method of claim 44, comprising selecting a subcarrier suggestion to be used by a narrowband wireless station among the subcarriers to be used by the wideband wireless station where channel status of the wideband wireless station is worse than for another of the subcarriers to be used by the wideband wireless station.

48. The method of claim 47, wherein the selecting of the suggested subcarriers comprises selecting a set of subcarriers of the subcarriers to be used by the wideband wireless station having the worst channel status and is not used by another narrowband wireless station.

49. The method of claim 44, comprising transmitting information about one or more sets of subcarriers expected to be interfered by narrowband stations to the wideband wireless station.

50. The method of claim 49, wherein the transmitting of the information about the one or more sets of subcarriers expected to be interfered by narrowband wireless stations is made along with the transmitting of the MCS suggestion.

51. A method of a wideband wireless station which is configured to operate under control of an access point which is configured to serve both wideband wireless stations and narrowband wireless stations where the narrowband wireless stations operate on a subset of the bandwidth on which the wideband wireless stations operate, the method comprising receiving information about at least one of
a modulation and coding scheme, MCS, suggestion about subcarriers to be used, and
one or more sets of subcarriers expected to be interfered by the narrowband wireless stations where the sets of subcarriers are subsets of the subcarriers to be used,
wherein the method further comprises
selecting an MCS based on the received information;
preparing a transmission to the access point based on the MCS selection; and
transmitting the prepared transmission.

52. The method of claim 51, comprising cancelling subcarriers corresponding to the one or more sets of subcarriers expected to be interfered by the narrowband wireless stations.

53. The method of claim 51, wherein the receiving of the information about the one or more sets of subcarriers expected to be interfered by the narrowband wireless stations comprises monitoring a channel between the access point and the wireless stations and acquiring the information therefrom.

54. The method of claim 51, wherein the received suggested MCS comprises a MCS which is adapted to have increased robustness in view of any interference on a transmission from the wideband wireless station to the access point caused by transmissions from the narrowband wireless stations, wherein the applied MCS for the preparing of transmissions to the access point is the suggested MCS.

55. The method of claim 51, wherein the applied MCS for the preparing of transmissions to the access point is based on the received suggested MCS, but is adapted to have increased robustness in view of any interference on a transmission from the wideband wireless station to the access point caused by transmissions from the narrowband wireless stations.
